(19) United States
(12) Patent Application Publication
(10) Pub. No.: US 2025/0303566 A1
(43) Pub. Date: Oct. 2, 2025

(54) System and Method for Robust In-Hand Robotic Manipulation

(71) Applicant: Mitsubishi Electric Research Laboratories, Inc., Cambridge, MA (US)

(72) Inventors: Devesh Jha, Cambridge, MA (US); Boyuan Liang, Berkeley, CA (US)

(73) Assignee: Mitsubishi Electric Research Laboratories, Inc., Cambridge, MA (US)

(21) Appl. No.: 18/616,373

(22) Filed: Mar. 26, 2024

(51) Int. Cl. B25J 9/16; B25J 15/08

(52) U.S. Cl. CPC B25J 9/1664; B25J 15/08

(57) ABSTRACT

A controller is provided for manipulating an object having at least one external contact by using a gripper of a robot arm having actuators. The controller includes a signal interface configured to receive a contact signal from the gripper and transmit a control signal to the actuators, a memory configured to store computer-implemented programs including an in-gripper mechanics model and a robust tuning framework, a processor configured to perform instructions of the computer programs. The instructions include steps of computing an object in-hand slippery of the gripper for the object based on the contact signal, computing a naive motion cone that maintains a desired contact mode assuming contact parameters between the object and the gripper, refining the naive motion cone based on an uncertainty range of each of the contact parameters, generating a manipulator position trajectory that minimizes the in-gripper slippery from the refined motion cone, and controlling the gripper according to the generated manipulator position trajectory by transmitting a gripper trajectory position signal to the actuators of the robot arm to reorient the object in the gripper using at least one external contact.

### TECHNICAL FIELD

This invention relates to a controller and method for robust contact-rich in-hand manipulation, and more particularly to methods and apparatus for manipulating an object having at least one external contact by using a gripper of a robot arm having actuators.

### BACKGROUND OF THE INVENTION

Humans are very skilled at performing dexterous manipulation. We can make very skillful use of various contacts (e.g., with the environment, our own body, etc.) to perform complex manipulation. In a striking contrast, achieving such dexterous behavior for robots remains very challenging. Using environmental contacts efficiently can provide additional dexterity to robots while performing complex manipulation. However, the current generation of robotic systems mostly avoid making contacts with their environment. Contact interactions lead to discontinuous dynamics which makes planning, estimation and control of contact-rich tasks challenging. Furthermore, the uncertainty in the involved parameters like the coefficient of friction, or grasping location of objects can often lead to failure of complex manipulation maneuvers.

Uncertainty is the norm rather than exception in the real world. There are several reasons for uncertainty. Perception and actuation errors for parts in the real world are very common. Even though there have been tremendous improvements in perception and learning algorithms, these errors still remain relevant to failures during execution. Consequently, to design robotic systems that can be deployed in the real world, with real sensory feedback, it is important to understand the mechanics of relevant manipulation tasks and design controllers which are robust to various parametric uncertainties.

This disclosure presents a method to perform a complex in-hand manipulation of an object using external contacts. In these methods, the robot manipulates the pose of an object which is grasped by the robot using a simple parallel-jaw gripper. The objective of the manipulation task is to re-orient the object while still in grasp. Since the gripper is a simple, parallel jaw gripper, the robot makes use of contact between the object and the environment to perform the manipulation. There are multiple contact formations in the proposed manipulation which makes the execution of the manipulation plan susceptible to various kinds of uncertainty. However, the state-of-the-art manipulation techniques cannot incorporate uncertainty during planning and control of these complex manipulation maneuvers and thus fail during the unavoidable uncertain execution circumstances. Thus, there is a requirement for techniques which can plan and implement robust manipulation behavior in the presence of various kinds of uncertainty.

### SUMMARY OF THE INVENTION

Recent times have seen huge improvements in the capabilities of Artificial intelligence (AI) technologies in the areas of computer vision and speech. However, robotics has not seen improvements at the same rate, and it still remains challenging to design robotic systems which can perform reliably in the real world while achieving robust execution.

Some embodiments of the current disclosure are based on the realization that a lot of complex manipulation tasks result in multiple contact formation. For example, consider the task where a robot equipped with a simple, parallel jaw gripper has grasped an object. The objective of the manipulation task is to change the grasp of the object to a pose which is not directly available in the free space, i.e., the robot cannot change the grasp pose by simply re-grasping the object.

Some embodiments of the current disclosure are based on the realization that manipulation of an object grasped by a simple, parallel-jaw gripper is an underactuated task for most objects. A robot can make use of contacts with an environment (e.g., at least one external contact) to manipulate the pose of an object while the object remains in grasp. However, making use of environmental contacts (e.g., at least one external contact) to manipulate the pose of an object results in an additional contact formation between the object and the environment. This contact formation could be very susceptible to uncertainty in various contact-related parameters.

Some embodiments of the current disclosure are based on the realization that perception errors lead to various kinds of parametric error in manipulation which could lead to failure of controller during execution of various complex manipulation maneuvers. It is important to consider these kinds of uncertainty during controller design for execution of various complex maneuvers. These parametric uncertainties could lead to several undesirable perturbation of the object from the planned trajectory which can lead to failures during execution. Thus, it is desirable that a planning algorithm be robust to various uncertainties like grasp center, extrinsic contact location, etc.

Some embodiments of the disclosure are based on the realization that maintaining external contact mode is crucial to the success of contact-rich in-hand manipulation tasks. The proposed disclosure presents a system and method which designs a manipulation controller while fully considering object in-hand slip (object in-hand slippery) and parametric uncertainties. We focus on two-finger gripper grasping and scenarios where only translational motion is allowed. The proposed robust manipulation framework also finds the gripper motion that minimizes in-hand translation of the object. This is to prevent the robot from losing grasp of the object. The proposed method focuses on two-finger gripper grasping and scenarios where only translational motion is allowed. The proposed robust manipulation framework also finds the gripper motion that minimizes in-hand translation of the object. This is to prevent the robot from losing grasp of the object.

Some embodiments of the current disclosure are based on the realization that the in-hand manipulation tasks with extrinsic contacts commonly poses two major challenges. In response to receiving a manipulation task command (task command or a task signal(s)) of by using a signal interface (hardware interface), the contact parameters and gripper motion, the system should predict the object motion in both the world and the gripper frame. This is nontrivial since the object is having contact-rich motion in the environment and sliding in the gripper simultaneously. The generated gripper trajectory should prevent unexpected contact mode transition against parametric uncertainties, especially kinematic parameters such as contact position and object dimensions.

The proposed disclosure presents a method that presents solution to the above two challenges while presenting a solution to robust controller design for robust in-hand manipulation with external contacts. This disclosure proposes a robust planning method for in-hand manipulation task while maintaining extrinsic contacts. Given a desired contact mode and uncertainty range of each parameter, it first uses an in-gripper mechanics model to compute the motion cone for each combination of vertex parameters of the uncertainty range and takes their intersection to obtain the robust motion cone. The controller obtained from the proposed method can be implemented on a physical robotic system with available on-board sensing such as vision, touch, F/T, etc.

According to some embodiments of the present disclosure, a controller is provided for manipulating an object having at least one external contact by using a gripper of a robot arm having actuators, including: a signal interface configured to receive a task command and a contact signal from the manipulator and transmit a control signal to the actuators; a memory configured to store computer-implemented programs including an in-gripper mechanics model, a parametric model of a manipulation task and a robust tuning framework; a processor configured to perform instructions of the computer programs, in association with the memory, wherein the instructions include steps of: computing an in-hand slippery of the object in the gripper using the in-gripper mechanics model; computing a motion cone that maintains a desired contact mode assuming contact parameters between the object and the gripper; refining the motion cone based on an uncertainty range of each of the contact parameters; generating a manipulator position trajectory that minimizes the object in-hand slippery from the refined motion cone; and controlling the manipulator according to the generated manipulator position trajectory by transmitting a manipulator position trajectory signal of the manipulator position trajectory to the actuators of the robot arm to reorient the object in the gripper using the at least one external contact.

Furthermore, some embodiments of the present disclosure provide a non-transitory computer-readable medium for manipulating an object having at least one external contact by using a manipulator and a gripper of a robot arm having actuators, including instructions stored thereon, that when executed on a processor, perform steps of: receiving, by using a signal interface, a task command and a contact signal from the manipulator and transmit a control signal to the actuators; computing an in-hand slippery of the object in the gripper using the in-gripper mechanics model; computing a motion cone that maintains a desired contact mode assuming contact parameters between the object and the gripper; refining the motion cone based on an uncertainty range of each of the contact parameters; generating a manipulator position trajectory that minimizes the object in-hand slippery from the refined motion cone; and controlling the manipulator according to the generated manipulator position trajectory by transmitting a manipulator position trajectory signal of the manipulator position trajectory to the actuators of the robot arm to reorient the object in the gripper using the at least one external contact.

### BRIEF DESCRIPTION OF DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

While the following drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

FIG. 1 shows a schematic representation of the typical failure of in-hand manipulation due to loss of extrinsic contact during manipulation while showing the success of the proposed robust manipulation controller.

FIG. 2 shows a schematic of the in-hand pose manipulation using extrinsic contact in the full 3D setting as well as its simplification used in this disclosure in 2D.

FIG. 3 shows the in-hand manipulation task and the associated model as well as control parameters considered in this disclosure.

FIG. 4A shows a limit surface for using the manipulation models considered in this disclosure for a feasible manipulation task.

FIG. 4B shows the feasible motion range using the manipulation models used in this disclosure for an in-hand manipulation task.

FIG. 5A shows a limit surface for using the manipulation models considered in this disclosure for an infeasible manipulation task.

FIG. 5B shows the feasible motion range using the manipulation models used in this disclosure for an infeasible in-hand manipulation task.

FIG. 6 shows the proposed robust manipulation framework for in-hand pose manipulation described in this disclosure.

FIG. 7 shows an example of a robust gripper movement trajectory computed using the method described in this disclosure.

FIG. 8 shows a robotic system designed with the proposed disclosure with different sensing modalities which can be used in the system.

FIG. 9 shows an example of a manipulation task where a robot is performing an in-hand manipulation task of a bottle by making contact with its external environment as some embodiment of the disclosure.

FIG. 10 shows an example manipulation task as some embodiment of the disclosure where a robot has to create a structure where the object is in an undesirable initial pose.

FIG. 11A shows an in-hand manipulation task using a single point contact according to embodiments of the present disclosure.

FIG. 11B shows measurements of sliding distance of the contact point during manipulation according to embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Some embodiments of the disclosure are based on the realization that contacts are central to most manipulation tasks. The desired goal is to allow robots human-like manipulation capabilities. Humans can perform very complex manipulation by making use of their fingers (e.g., two fingers), body as well as the environment to support the mechanics of manipulation and react to unforeseen disturbances. These tasks go much further beyond the traditional pick-and-place tasks in terms of complexity of planning and control. Designing controllers which can achieve human-like physical intelligence for robots has the long standing, and the most challenging problem in robotics and artificial intelligence.

However, robots, in general, struggle to make effective use of contacts resulting in poor manipulation capabilities. These contacts during manipulation can occur between an object and a robot as well as between an object and its environment while the robot is trying to manipulate the object. In general, these tasks are underactuated meaning that the robot some of the contact formations cannot be directly controlled by the robot. This makes manipulation tasks very susceptible to failures.

Some embodiments of the disclosure are based on the realization that one of the major reasons for poor performance of manipulation controllers is the uncertainty in the kinematic as well as physical parameters when working with novel objects, i.e., the objects for which the robot does not have prior models. Most of the state-of-the-art vision techniques used to estimate the location or pose of an object may not provide enough precision to perform the task accurately. However, through testing and verification it might be possible to estimate the uncertainty of the estimates of the different parameters that might be related to a particular manipulation task.

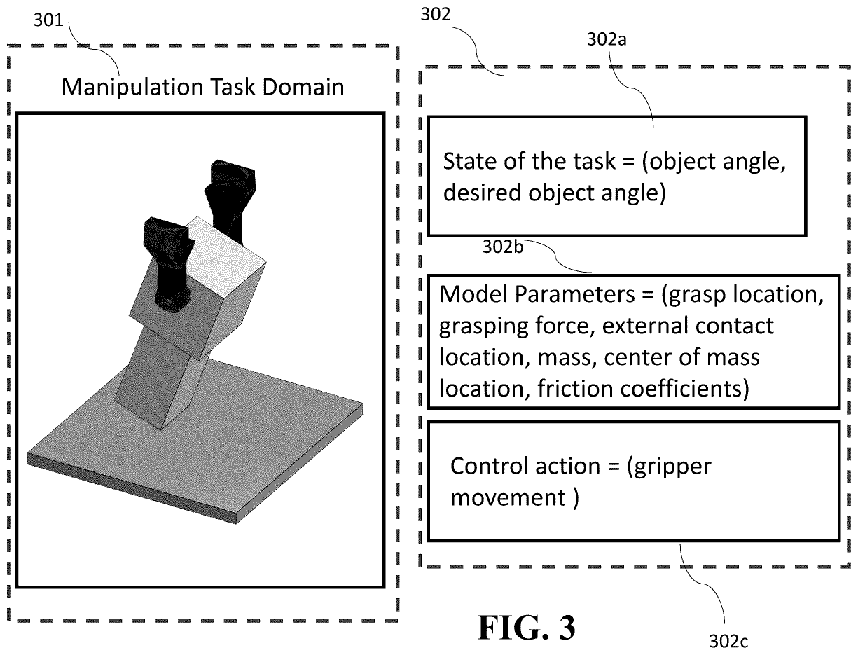

FIG. 3 shows the in-hand manipulation task and the associated model as well as control parameters as some embodiment of this disclosure. FIG. 3 shows an example manipulation task 301 as an embodiment. The manipulation task (manipulation task command) has several sets of parameters 302 which needs to be considered for planning in this task. In some embodiment, the state of the manipulated task could be represented by the orientation of the object (object angle) and desired object angle 302a. Similarly there are lot of modeling parameters 302b like the grasp location, grasping force, external contact location, mass of the object, center of mass location, and coefficient of friction between the various surfaces, etc. 302b which can affect the manipulation task. The robot control actions could be the in-gripper movement, the forces it can apply 302c to perform the desired manipulation.

Some embodiments of the current disclosure are based on the realization that a manipulation planning framework can make use of the uncertainty estimates in the relevant parameters to design and compute controllers which are robust to these uncertainties. These controllers can provide robustness in parametric uncertainty during manipulation in the real world where these parameters need to be estimated for novel objects and might be uncertain. These uncertainties are particularly important to consider for manipulation of small parts which are generally difficult to be observed using a general-purpose vision system.

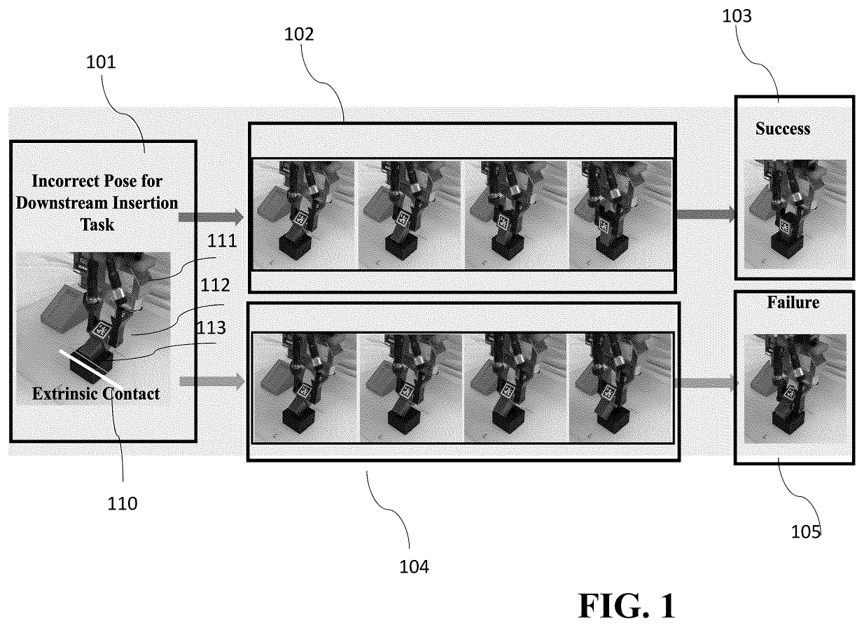

FIG. 1 shows an example scenario where a robot attempts to manipulate the pose of a peg 113 which must be inserted for an assembly task 103. The current grasp of the peg 113 is not suitable for the downstream assembly task 102.

Some embodiments of the disclosure are based on the realization that robots with simple dexterity have limited capability of performing manipulation since the gripper may not be sufficiently actuated or have very limited range of movement. However, in some cases, the robot can make use of the environment to compensate for the limited dexterity and perform manipulation. Since the robot is equipped with a simple gripper 111 with parallel fingers 112 with single degree-of-freedom. The parallel fingers 112 may be a two finger gripper or the number of fingers of the griper may be two or more than two. In some cases, the number of fingers may be two or more. This makes the task of re-orienting the peg difficult, and the robot must make of the extrinsic contact 110 between the peg 113 and the environment to re-orient the peg.

FIG. 1 shows a schematic representation of the typical failure of in-hand manipulation due to loss of extrinsic contact during manipulation while showing the success of the proposed robust manipulation controller. In the figure, we show the case where a controller without considering the uncertainties in the grasping location of the peg ends up losing contact 104 with the external environment and thus, it cannot reorient the peg to perform insertion. However, a controller designed while considering the possible uncertainty in the grasp location can maintain the contact between the peg and the environment. The robot successfully finishes the task of reorienting the peg 102 so that it can finish the downstream insertion task 103.

Some embodiments of the disclosure are based on the realization that it is important to establish and create to reliable model for the contact-rich manipulation techniques. This is motivated by the fact that the mechanism of a manipulation task can provide information regarding the various relevant parameters and help identify the most susceptible parameters which can lead to failure of the manipulation task.

Some embodiments of the disclosure are based on the realization that to derive a robust controller for in-hand manipulation, we would need an accurate parametric model for the in-gripper motion of the object which can be refined for robustness using the uncertainty estimates of the parameters. While the full model could be very complex requiring very detailed analysis of friction cone of the manipulation task. Thus, we consider a simplified model of the task in 2D which can be easily analyzed without comprising on the predictive capability.

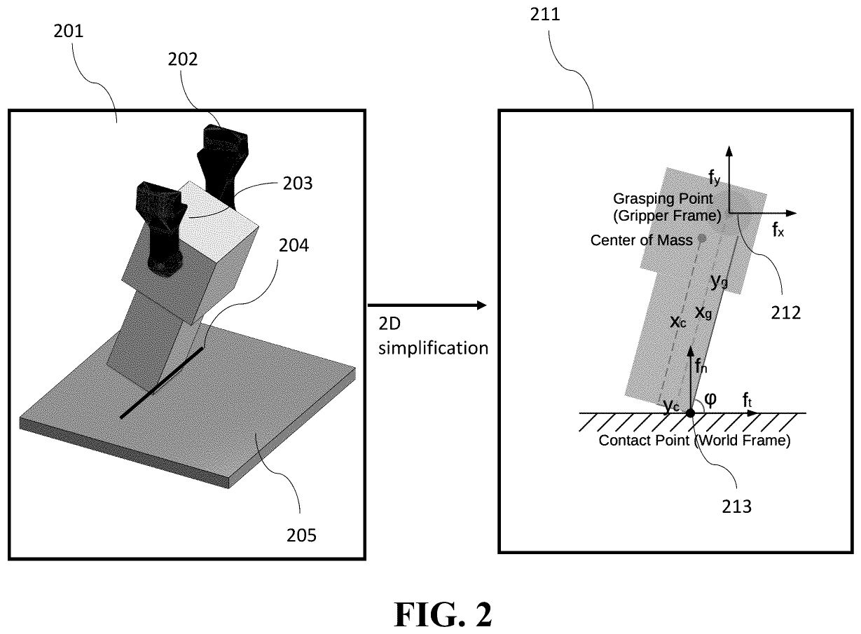

FIG. 2 shows an example scenario of the in-hand manipulation task in full 3D 201 and its simplification in 2D 211. In the original configuration, the object 203 in grasp of the fingers 202 make an extrinsic line contact 204 with the environmental surface 205. In the 2D simplification 211, the full line-contact 204 is replaced with a point contact 213. The grasp contact patch is simplified as the contact patch 212.

Some embodiments are based on the realization that since we focus on a parallel-jaw gripper, the system can be approximated into a 2D contact model (in-gripper mechanics model) and the gripper forms a patch contact with the object. Assume the object maintains N contact points with the environment, we denote their contact positions and contact normals in the gripper frame by {pᵢ}ᵢ₌₁^{N}⊂ [symbol] ² and {nᵢ}ᵢ₌₁^{N}⊂ [symbol] ². Boolean variables {CCᵢ}ᵢ₌₁^{N} state if the object is rotating counter-clockwise around the contact point. Integers {SLᵢ}ᵢ₌₁^{N}⊂{−1,0, +1} states if the contact point i is left-sliding, sticking or right sliding. A separating contact point is not considered as a contact point to maintain in the manipulation. {pᵢ, nᵢ, CCᵢ, SLᵢ}ᵢ₌₁^{N} together quantitatively represents the contact mode. We decompose the object generalized velocity in world frame v_{w}=[\dot{x}_{w} \dot{y}_{w} \dot{θ}_{w}] into its motion in gripper frame vₕ and gripper motion in world frame v_{g}. Since the robot hand has a fixed orientation, we have v_{g}=v_{w}+(−vₕ). The in-gripper mechanics model targets to find a feasible motion cone Θ_{g} of v_{g} to maintain the desired contact mode and predict v_{w} and −vₕ.

Some embodiments of the disclosure are based on the realization that since the gripper makes a patch contact with the object, we use a second-order limit surface (LS) as the load-motion mapping of the in-gripper slip, where the applicable friction wrench wₕ=[fₓ f_{y} m_{z}] may be given from the object to the gripper is bounded by an ellipsoid.

$${( \frac{{f}_{x}}{{μ}_{g} {N}_{g}} )}^{2} + {( \frac{{f}_{y}}{{μ}_{g} {N}_{g}} )}^{2} + {( \frac{{m}_{z}}{κ {μ}_{g} {N}_{g}} )}^{2} \leq 1 \qquad ( 1 )$$

where μ_{g} and N_{g} are the coefficient of friction between the object and the gripper finger, and the grasping force respectively. κ is an integration constant. For uniformly distributed circular patch contact, κ≈0.6 r, where r is the radius of the contact patch.

Some embodiments are based on the realization that in-hand slip occurs only for equality constraints in (1). Since our objective is in-hand pose adjustment, we can assume equality constraint in (1) is always activated throughout the motion trajectory. By the principle of maximal dissipation, the in-hand motion vₕ=[vₓ v_{y} ω]^{T} should be vertical to the LS at the wrench point.

$${v}_{h} = {α [ \frac{{f}_{x}}{{( {μ}_{g} {N}_{g} )}^{2}} \frac{{f}_{y}}{{( {μ}_{g} {N}_{g} )}^{2}} \frac{{m}_{z}}{{( κ {μ}_{g} {N}_{g} )}^{2}} ]}^{T} \qquad ( 2 )$$

α≥0 is a proportional constant. Given the desired contact mode, the possible range of −vₙ and v_{w} are respectively named by Wrench Motion Set (WMS) and Environmental Motion Set (EMS).

Some embodiments are based on the realization that the load-motion mapping (2) provides a bridge to infer WMS from the set of all possible wₕ, which is the wrench set (WS). Each contact point will contribute one or two wrench rays to the motion cone, and their non-negative linear combination plus the gravitational wrench will formulate the wrench set.

Some embodiments are based on the realization that due to the linear complementarity conditions of the Coulomb friction model in 2D space, there can only be either one or two wrench rays in total including all contact points. If there is only one wrench ray, this contact mode has two degrees of freedom (DoF); if there are two wrench rays, this contact mode has only one DoF. We mainly discuss the case when there are two wrench rays, the case with only one wrench ray can be treated as a degenerated special case. Denote the gravitational wrench in the gripper frame as G and wrench rays provided from contact points in the gripper frame as w₁ and w₂, the wrench set can be mathematically interpreted as

$$W S = \{ G + {t}_{1} {w}_{1} + {t}_{2} {w}_{2} \vert {t}_{1} , {t}_{2} \geq 0 \} \qquad ( 3 )$$

Since we assumed that gripper friction can lift the peg, so G must fall in the LS. As such, WS must have a non-empty intersection with the LS. Since the LS has an ellipsoid shape, the intersection of WS and LS will be a 3D ellipse arc in the wrench space, which can have the following parameterized representation.

$$\vec{s} ( θ ) = \vec{m} + \vec{a} cos θ + \vec{b} sin θ , θ ∈ [ {θ}_{l} , {θ}_{h} ] \qquad ( 4 )$$

Combining with (2), WMS can be represented as

$$W M S = α \frac{\vec{m} + \vec{a} cos θ + \vec{b} sin θ}{[ {( {μ}_{g} {N}_{g} )}^{2} {( {μ}_{g} {N}_{g} )}^{2} {( κ {μ}_{g} {N}_{g} )}^{2} ]} \\ θ ∈ [ {θ}_{l} , {θ}_{h} ] , α \geq 0 \qquad ( 5 )$$

The division is element-wise. For convenience, we denote the right-hand side of (5) by αv_{WMS}(θ).

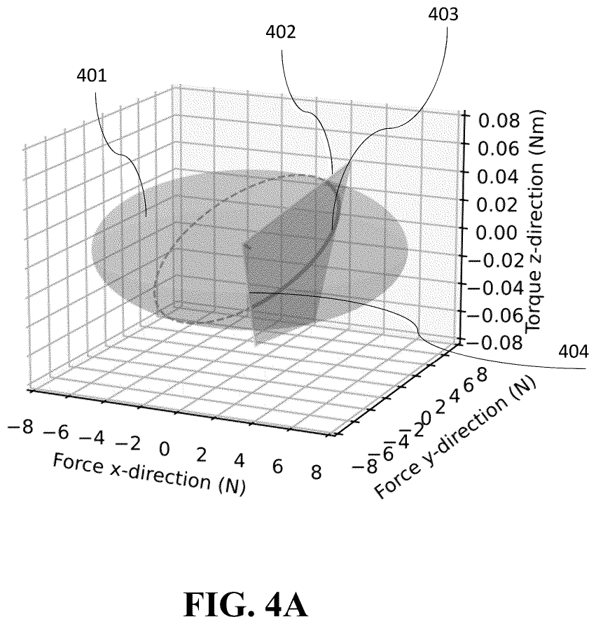

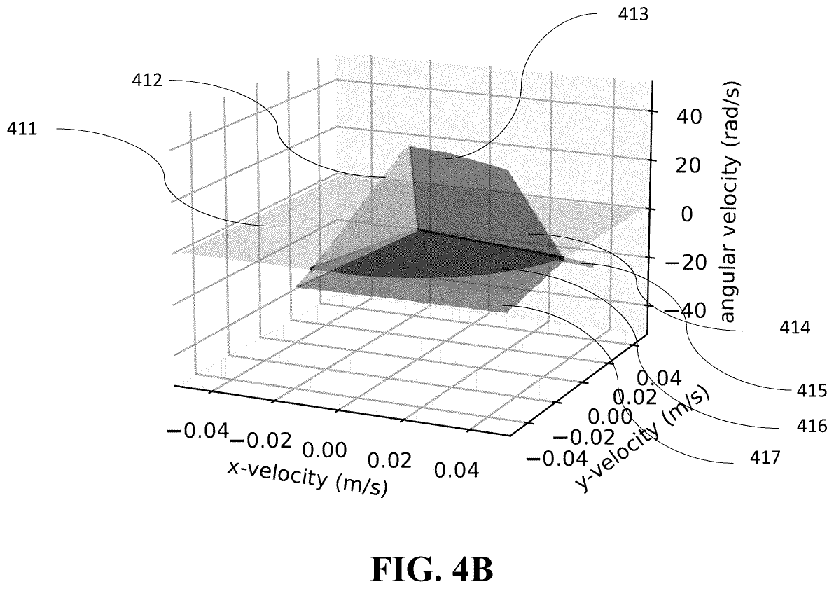

FIG. 4A shows a limit surface for using the manipulation models considered in this disclosure for a feasible manipulation task. The figure shows an example for visualizing WS and WMS. The robot needs to rotate the peg clockwise around the line contact while maintaining the contact line sticking with translational motion only. The contact plane is assumed to have a coefficient of friction of 0.2. The center of mass locates at x_{c}=0.041 m, y_{c}=0.1 m, and the grasping point locates at x_{g}=0.01 m, y_{g}=0.06 m. The gripper has a coefficient of friction of 0.4 and a grasping force of 20 N. The grasping is approximated as a uniform circular patch contact with a radius of 0.01 m. The ellipsoid 401 is the limit surface (LS) in (1). The two rays 402, 404 and their spanned wrenches are respectively frictional wrenches w₁, w₂ and wrench set (WS) in (3). The intersection between WS and LS is shown in FIG. 4A as the solid arc 403. FIG. 4B shows the feasible motion range using the manipulation models used in this disclosure for an in-hand manipulation task. Taking the vertical ray on each point of the solid arc gives wrench motion set (wrench motion space) (WMS), as shown by the surface 412 in FIG. 4B. To infer the motion cone Θ_{g}, we also need to compute EMS, which is explained next.

Some embodiments are based on the realization that computing EMS is rather straightforward from contact kinematics constraints. These constraint equations depend on contact mode representation {pᵢ, nᵢ, CCᵢ, SLᵢ}ᵢ₌₁^{N}. For example, the sticking line contact in FIG. 1 has contact mode

$${p}_{1} = [ \begin{matrix}{x}_{g} cos θ - {y}_{g} sin φ \\ {x}_{g} sin θ + {y}_{g} cos φ\end{matrix} ]$$

$${n}_{1} = [ \begin{matrix}0 \\ 1\end{matrix} ]$$

$$C {C}_{1} = False$$

$${SL}_{1} = 0$$

It has only one DoF, so the EMS becomes a single ray, which is shown by the line 415 in FIG. 4B.

$$E M S = \{ {β [ \begin{matrix}{p}_{1 , y} & - {p}_{1 , x} & - 1\end{matrix} ]}^{T} \vert β \geq 0 \}$$

Some situations can have two DoFs, then EMS will become a linear cone spanned by the two motion rays.

Some embodiments are based on the realization that the feasible motion cone that maintains the desired contact mode is the Minkowski sum of WMS and EMS, WMS ⊕ EMS, which is the cone spanned by two planes 414, 417 and the surface enclosed by 412. 414 is the gravity wrench. Since the gripper is only allowed translational motion, we take the intersection with the ω=0 plane, which forms the motion cone Θ_{g}, visualized by the surface 416 in FIG. 4B. We quantitatively describe Θ_{g} as an angle range [Θ_{g,1}, Θ_{g,2}]. Given a gripper motion v_{g} in the motion cone, it can be uniquely decomposed into a motion in WMS and EMS, which predicts object in-gripper motion.

$${v}_{g} = {v}_{w} + ( - {v}_{h} ) , - {v}_{h} ∈ W M S {v}_{w} ∈ E M S \qquad ( 6 )$$

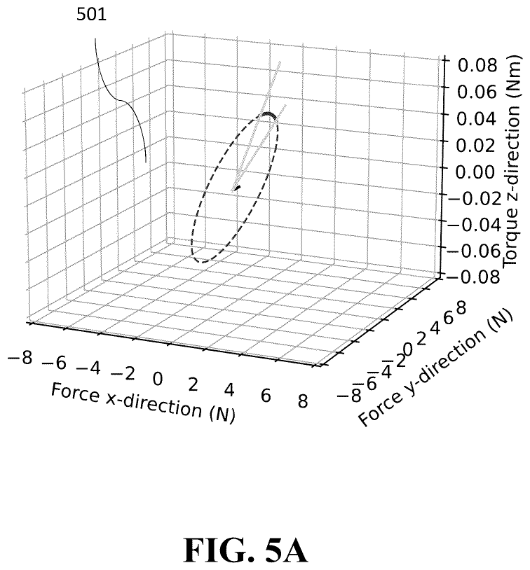

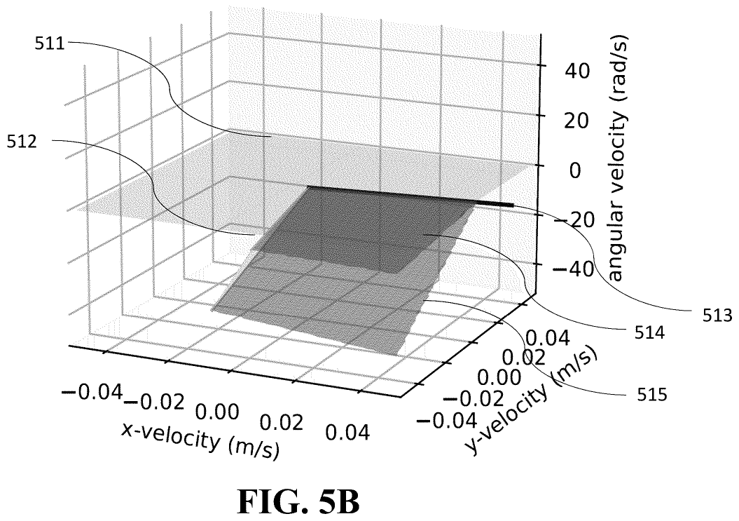

Some embodiments are based on the realization that there are also cases when the Minkowski sum of WMS and EMS does not intersect with the ω=0 plane. This happens when it is infeasible for the robot to maintain the desired contact mode with only translational motion. FIG. 5 gives an example for this case, when φ=90° and μ=0.1. Every translational motion will make the contact point slip due to the small μ, so Θ_{g}=Ø.

FIG. 5A shows the LS 501 for this case, and FIG. 5B shows the feasible motion range using the manipulation models used in this disclosure for an infeasible in-hand manipulation task. 513 in FIG. 5B is the gravity wrench. As shown in FIG. 5B, the intersection between the surfaces 511, 512, 514 and 515 is empty showing that the desired manipulation task is infeasible. This is a geometrical interpretation that intersection of WMS ⊕ EMS with ω=0 plane is a null set, indicating Θ_{g}=Ø.

Some embodiments are based on the realization that the motion cone computed by Equations (1)-(5) assumes a precise estimation of each contact parameter. We can refine the motion cone to make it robust against parametric uncertainties. Using ξ∈ [symbol] ⁿ to denote the set of parameters whose uncertainties will be considered. For each entry ξᵢ of ξ (uncertainty parameters), let its uncertainty range be [ξᵢ−Δξᵢ, ξᵢ+Δξᵢ], and we use Δξ to denote the collection of Δξᵢ. Each different combination of parameter in the n-dimensional cuboid \tilde{ξ}∈ξ+Δξ generates different motion cones Θ_{g,ξ}. By definition, the robust motion cone Θ̅_{g} should be determined by the intersection of Θ_{g,ξ} off all possible \tilde{ξ}. When Δξᵢ is relatively small compared to ξᵢ, the motion cone Θ_{g,ξ} approximately changes monotonically in the uncertainty range with each single parameter ξᵢ when other parameters are fixed. Therefore, Θ̅_{g} can be approximated as the intersection of motion cone generated by vertices of the n-dimensional cuboid ξ±Δξ.

$$[ {\overline{Θ}}_{g , 1} , {\overline{Θ}}_{g , 2} ] \text{=:} {\overline{Θ}}_{g} = {⋂}_{\vec{ξ} ∈ 𝒱 ( ξ \pm Δ ξ )} {Θ}_{g , \vec{ξ}} \qquad ( 7 )$$

With the computed robust motion cone Θ̅_{g}, many search-based planning methods such as RRT search can be directly deployed.

Some embodiments are based on the realization that we can estimate v_{g}^{(t)} that minimizes the translational part of −vₕ^{(t)} given the desired object single-step world motion v_{w}^{(t)} in EMS. We found that due to the non-linear constraints, optimizers can easily get stuck in an infeasible local minimum. Therefore, a sample-based approach is applied. We uniformly sample θ in [θₗ, θᵤ] with gap δθ, and then solve α≥0, β≥0 and Θ∈Θ̅_{g} that satisfies the following equality constraints:

$${[ \begin{matrix}cos Θ & sin Θ & 0\end{matrix} ]}^{T} = α {v}_{W M S} ( θ ) + β {v}_{w}^{( t )} \qquad ( 8 )$$

For a given θ, if a solution of α, β, and Θ cannot be found, then the robust condition cannot be met. This choice of θ should be skipped. The θ that gives the smallest α will be selected. As for forward kinematics, the solved β and α are sufficient to predict the object world motion and in-gripper slip. The sample-based optimization for θ is repeated in the next time step until the goal pose is reached.

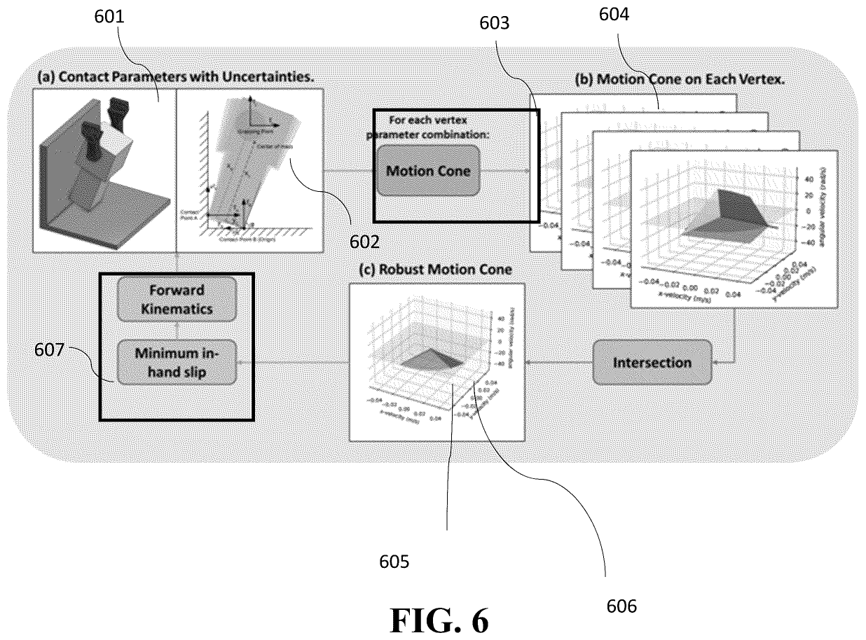

FIG. 6 shows the proposed robust manipulation framework for in-hand pose manipulation described in this disclosure. FIG. 6 gives an overview of the robust planning method and an example of a planned robust trajectory from φ=38° to 90° 601. The robot needs to pivot the peg while ensuring the two contact points do not separate 601. The mass and COM position is shown in 602. The horizontal and vertical contact plane has respectively 0.1 and 0.12 coefficients of friction, and the gripper is grasping at location x_{g}=0.055 m and y_{g}=0.0135 m as shown in 602. The bottom length of the object is 0.027 m. We can see that Θ̅_{g} is a subset of Θ_{g} that further ensures contact mode under parametric uncertainties. The motion cone 603 generated from each vertex in ξ±Δξ 604. The robust motion cone by taking the intersection in (8), the wedge 605 is the naïve motion cone assuming parameters are accurate, where the wedge 606 is the robust motion cone. The control actions are generated using the forward kinematics to minimize the in-hand slip (object in-hand slippery) 608.

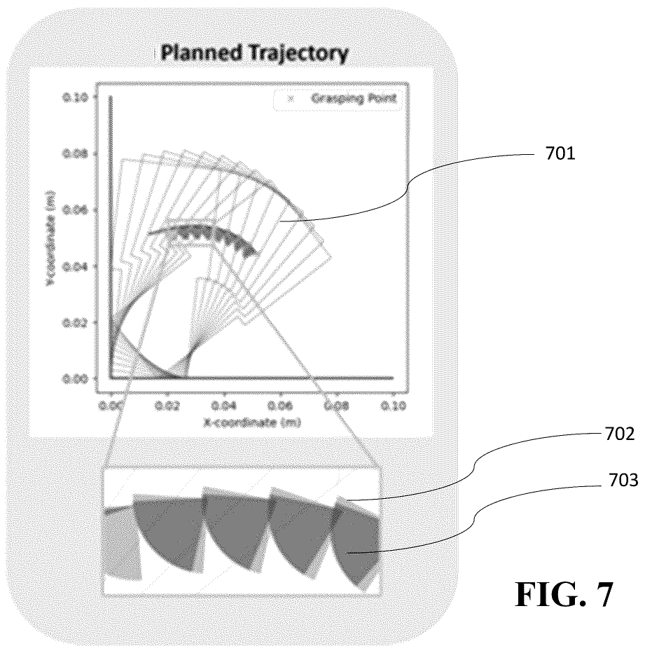

FIG. 7 is an example of a robust manipulator movement trajectory computed using the method described in this disclosure. FIG. 7 shows the computed trajectory (gripper position trajectory or manipulation position trajectory) 701 for the in-hand manipulation task from φ=40 to 85. The robust motion cone is shown as 703 which is smaller than the basic motion cone 702 and starts shrinking as we progress in the task showing that beyond a certain orientation of the object in grasp, it is not possible to provide additional robustness.

It is noted that the control signal as the output of the robust planning method could be expressed as the gripper trajectory of the manipulator end-effector trajectory. These two could often be used interchangeably as the manipulator trajectory can be easily transformed into the gripper trajectory by performing a rigid transform between the two coordinates.

We next verify the effectiveness of the robust planning method by comparison with naive planning. The example in FIG. 1 is again used as the first testing case. We consider the uncertainty against the grasping point (x_{g} and y_{g}) and the COM position (x_{c} and y_{c}). We assumed the grasping point and COM position have 3 mm uncertainty in both x and y direction and generated the gripper position trajectory (manipulator position trajectory) using the robust planning method. The benchmark trajectory is generated from the naive planning method. We intentionally added ±2 mm displacement, respectively, to the x and y coordinates of the grasping point and compared the performance of robust and naive planning. The results are summarized in table 1. Robust planning was able to ensure contact point sticking in almost all cases, while naive planning showed detectable contact point slippery (object in-hand slippery). The robust planning also had a 1.7 mm slip when both the x and y coordinates of the grasping point have −2 mm displacement. This is most likely because the contact point fell out of the planned uncertainty range in this setting. Snapshots of naive and robust planning are shown in FIG. 1.

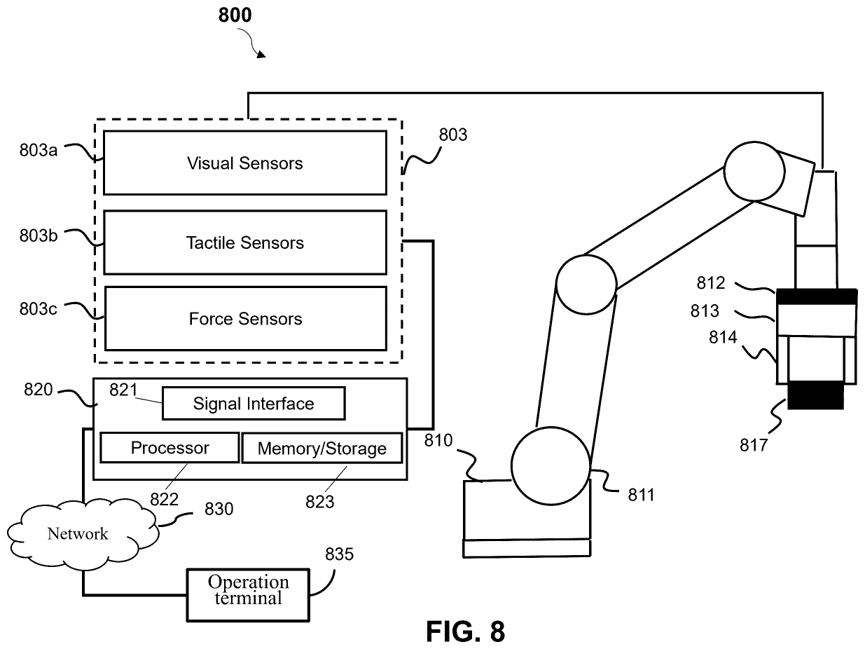

FIG. 8 shows a robotic system 800 designed with the proposed disclosure with different sensing modalities 830 (e.g., vision 803a, tactile 803b, force sensors 803c, etc.) which can be used in the system. A robotic system 800 may include a controller 820 having at least a signal interface 821, a processor 822, and a memory 823. The controller 820 is configured to connect to an operation terminal 835 via a network 830. The controller 820 can receive a manipulation task command including parameters via the signal interface. In this case, the parameters may include a state of a task, model parameters, and a control action, wherein the manipulation task command is inputted by an operator using the operation terminal 835 via the network 830. The network 830 may be a wireless communication link, a wired link, an optical fiber communication link, or part of combinations of thereof. The controller 820 may start controlling a robot arm 810 using the processer 822 that starts performing the steps of computer-implemented instructions stored in the memory/storage 823 in response to receiving the manipulation task command via the signal interface 821. The robot arm 810 includes joints 811 including actuators, links, and a manipulator unit 812, 813 including a gripper 814 with fingers. The circuitry, which may be may be arranged separately from or included in the robot arm 810, is configured to operate the actuators and the manipulator unit and the gripper 814 to perform a task provided from the controller 820 operated by an operator using the operation terminal 835. The figure illustrates that the gripper fingers grasp an object 817.

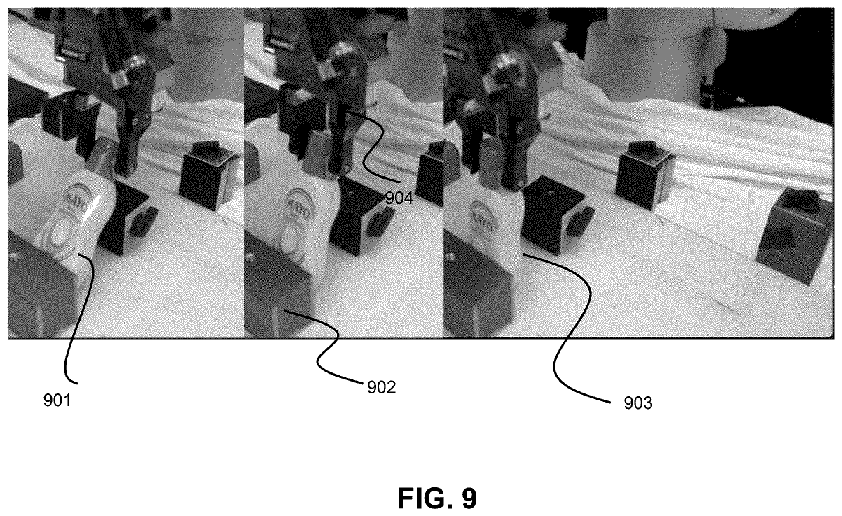

FIG. 9 shows another example of an in-hand manipulation task as some embodiment of this disclosure, indicating a series of the poses of an object 901 while being manipulated by a robot (manipulator) 904. The robot 904 manipulates the pose of the object 901 from an initial pose 901 to some desired pose 903 using the external environment 902.

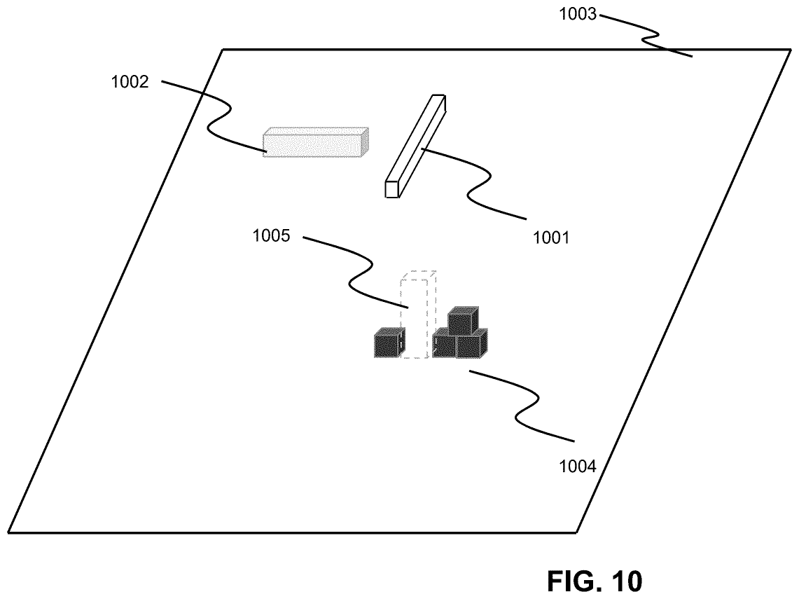

FIG. 10 shows yet another example of a possible application as some embodiments of the disclosure. The task is to create a structure 1004 on a table-top surface 1003. The robot needs to manipulate the object 1002 from an initial configuration 1002 to a desired configuration 1005. The table-top surface also has a manipulation station 1001 that the robot can potentially use during the task. The robot can use some embodiments of the proposed disclosure to re-orient the object 1002 from its initial configuration to the desired configuration 1005 to complete the desired structure 1004.

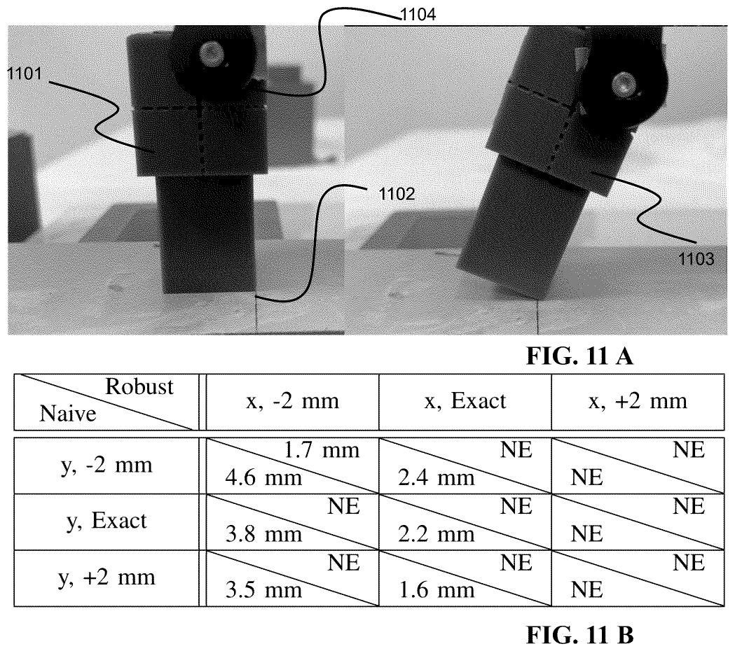

FIG. 11A shows another in-hand manipulation task according to some embodiments of this disclosure. The task is to change the orientation of the peg from 1101 to 1103 using the external line contact 1102. To show the robustness of the proposed controller, we perform a series of experiments by changing the grasp location 1104 from the known perfect location 1104. We approximately measure the slip incurred at 1102 during the manipulation task. FIG. 11B shows measurements of sliding distance of the contact point during manipulation according to embodiments of the present disclosure. The results for various values of noise added to the perfect grasp location is shown in FIG. 11B. The objective here is to minimize the slip occurring at the external contact location 1102. As could be seen in FIG. 11B, the proposed robust controller outperforms the baseline controller in minimizing the slip during the process.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the disclosure has been described by way of examples of preferred embodiments, it is to be understood that various other adaptations and modifications can be made within the spirit and scope of the invention.

Therefore, it is the object of the appended claims to cover all such variations and modifications as come within the true spirit and scope of the invention.

1. A controller for manipulating an object having at least one external contact by using a gripper of a robot arm having actuators, comprising:
a signal interface configured to receive a task command and a contact signal from the manipulator and transmit a control signal to the actuators;
a memory configured to store computer-implemented programs including an in-gripper mechanics model, a parametric model of a manipulation task and a robust tuning framework;
a processor configured to perform instructions of the computer programs, in association with the memory, wherein the instructions include steps of:
computing an in-hand slippery of the object based in the gripper using the in-gripper mechanics model;
computing a motion cone that maintains a desired contact mode assuming contact parameters between the object and the gripper;
refining the motion cone based on an uncertainty range of each of the contact parameters;
generating a manipulator position trajectory that minimizes the object in-hand slippery from the refined motion cone; and
controlling the manipulator according to the generated manipulator position trajectory by transmitting a manipulator position trajectory signal of the manipulator position trajectory to the actuators of the robot arm to reorient the object in the gripper using the at least one external contact.

2. The controller of claim 1, wherein the motion cone for an in-gripper movement of an object is expressed by a Minkowski sum of a wrench motion space (WMS) and an environmental motion set (EMS).

3. The controller of claim 1, where a robust motion cone for a robust in-hand manipulation is obtained by taking intersection of the motion cone computed for each of the contact parameters in the uncertainty range.

4. The controller of claim 1, where an in-gripper mechanics model is used to compute a feasible motion cone of a grasped object while maintaining the desired contact mode with at least one external contact with an environment.

5. The controller of claim 1, wherein the motion cone is computed based on the in-gripper mechanics model for each combination of vertex parameters of the uncertainty range.

6. The controller of claim 1, wherein a robust motion cone is determined by an intersection of different motion cones.

7. The controller of claim 1, wherein the processer starts performing the steps in response to receiving a manipulation task command including parameters via the signal interface, wherein the parameters include a state of a task, model parameters, and a control action, wherein the manipulation task command is inputted by an operator using an operation terminal connected to the controller via a network to the signal interface.

8. The controller of claim 1, wherein the gripper is a two finger gripper.

9. The controller of claim 1, wherein the manipulator position trajectory maintains the at least one external contact with the object while controlling the gripper.

10. The controller of claim 1, wherein the processor starts performing the steps of the instructions in response to the task command.

11. A non-transitory computer-readable medium for manipulating an object having at least one external contact by using a manipulator and a gripper of a robot arm having actuators, comprising instructions stored thereon, that when executed on a processor, perform steps of:
receiving, by using a signal interface, a task command and a contact signal from the manipulator and transmit a control signal to the actuators;
computing an in-hand slippery of the object based in the gripper using an in-gripper mechanics model;
computing a motion cone that maintains a desired contact mode assuming contact parameters between the object and the gripper;
refining the motion cone based on an uncertainty range of each of the contact parameters;
generating a manipulator position trajectory that minimizes the object in-hand slippery from the refined motion cone; and
controlling the manipulator according to the generated manipulator position trajectory by transmitting a manipulator position trajectory signal of the manipulator position trajectory to the actuators of the robot arm to reorient the object in the gripper using the at least one external contact.

12. The non-transitory computer readable medium of claim 11, wherein the motion cone for an in-gripper movement of an object is expressed by a Minkowski sum of a wrench motion space (WMS) and an environmental motion set (EMS).

13. The non-transitory computer readable medium of claim 11, where a robust motion cone for a robust in-hand manipulation is obtained by taking intersection of the motion cone computed for each of the contact parameters in the uncertainty range.

14. The non-transitory computer readable medium of claim 11, where an in-gripper mechanics model is used to compute a feasible motion cone of a grasped object while maintaining the desired contact mode with at least one external contact with an environment.

15. The non-transitory computer readable medium of claim 11, wherein the motion cone is computed based on the in-gripper mechanics model for each combination of vertex parameters of the uncertainty range.

16. The non-transitory computer readable medium of claim 11, wherein a robust motion cone is determined by an intersection of different motion cones.

17. The non-transitory computer readable medium of claim 11, wherein the processer starts performing the steps in response to receiving a manipulation task command including parameters via the signal interface, wherein the parameters include a state of a task, model parameters, and a control action, wherein the manipulation task command is inputted by an operator using an operation terminal connected to the controller via a network to the signal interface.

18. The non-transitory computer readable medium of claim 11, wherein the gripper is a two finger gripper.

19. The non-transitory computer readable medium of claim 11, wherein the manipulator position trajectory maintains the at least one external contact with the object while controlling the gripper.

20. The non-transitory computer readable medium of claim 11, wherein the processor starts performing the steps of the instructions in response to the task command.
